(19) United States
(12) Patent Application Publication
(10) Pub. No.: US 2025/0091452 A1
(43) Pub. Date: Mar. 20, 2025

(54) GLASS FIBER-BASED ENERGY STORING COMPOSITES AS HIGH STRENGTH STRUCTURAL PANELS

(71) Applicant: University of Central Florida Research Foundation, Inc., Orlando, FL (US)

(72) Inventors: Jayan Thomas, Orlando, FL (US); Deepak Pandey, Orlando, FL (US); Rajkumar Gurjar, Orlando, FL (US); Maydenee Maydur Tresa, Orlando, FL (US)

(73) Assignee: University of Central Florida Research Foundation, Inc., Orlando, FL (US)

(21) Appl. No.: 18/776,924

(22) Filed: Jul. 18, 2024

Related U.S. Application Data
(60) Provisional application No. 63/538,861, filed on Sep. 18, 2023.

(51) Int. Cl. B60L 50/64; B60L 50/40; B62D 29/04; H01G 11/04; H01G 11/10; H01G 11/26; H01G 11/52; H01G 11/62; H01M 10/0565; H01M 10/058; H01M 50/437; H01M 50/44; H01M 50/457

(52) U.S. Cl. CPC B60L 50/64; B60L 50/40; H01G 11/04; H01G 11/10; H01G 11/26; H01G 11/52; H01G 11/62; H01M 10/0565; H01M 10/058; H01M 50/437; H01M 50/44; H01M 50/457; B62D 29/043; H01M 2300/0085

(57) ABSTRACT

A glass fiber-based structural composite offers an alternative or supplement to carbon fibers in areas such as battery storage. Through electroless deposition of conductive materials like copper and nickel, the glass fiber surface is made conducting and functions as a good current collector. By using anode and cathode materials like manganese (II, III) oxide and Zinc, cathode and anode mats on the copper- and nickel-coated glass fibers are created via hydrothermal and electro-deposition methods. In one example application, the anode and cathode mats are in an alternate square patterned arrangement using copper and nickel-coated glass fiber as a current collector. The device, with a capacity of >300 mAh/g at 0.1 A/g is assembled using an alternate system of epoxy and electrolyte. Uncoated pristine glass fiber ladened and patterned with electrolyte are used as a separator. Uncoated pristine glass fiber ladened with epoxy can be used as an insulator between two devices.

### RELATED PATENTS AND APPLICATIONS

This disclosure relates to U.S. Pat. No. 11,686,011 issued Jun. 27, 2023 and entitled “Vertically-Aligned Graphene-Carbon Fiber Hybrid Electrodes And Methods for Making Same”; U.S. patent application Ser. No. 17/518,985 filed Nov. 4, 2021 and entitled “Storing Energy in Carbon Fiber-Based Electric Vehicle Body Panels”; U.S. patent application Ser. No. 17/842,145 filed Jun. 16, 2022 and entitled “Dual Function Energy-Storing Supercapacitor-Based Carbon Fiber Composite for Body Panels of A Vehicle”; and International Patent Application No. PCT/US2022/033881 filed Jun. 16, 2022 and entitled “Dual Function Energy-Storing Supercapacitor-Based Carbon Fiber Composite for Body Panels of A Vehicle”, the entire contents of all of which are hereby incorporated by reference in their entirety.

### STATEMENT REGARDING FEDERALLY SPONSORED RESEARCH OR DEVELOPMENT

This invention was made with Government support under Award #IIP 2122779, awarded by the National Science Foundation. The Government has certain rights in the invention.

### FIELD OF THE DISCLOSURE

The disclosure relates to a novel approach to storing energy, for example to power electric vehicles, by using glass fiber-based composite batteries or hybrid supercapacitor battery device as one or more structural panels such as body panels of the electric vehicle.

### BACKGROUND

As electric vehicle (EV) manufacturers are struggling to bring down the cost of EVs given the rising price of battery materials, new and cheaper methods of storing energy could help the EV industry make electrical cars more affordable to the general population. Structural energy storage devices such as structural batteries and structural supercapacitors are a unique way of solving the problem of range anxiety and at the same time making the EVs lighter in weight. However, these structural battery and supercapacitor hybrids often use expensive carbon fiber as the current collector and a load bearing member of the structural composite. Though carbon fibers exhibit very high mechanical properties (especially tensile strength) and acceptable electrical conductivity, cost considerations could prevent mass commercialization in the form of a structural battery for EV applications.

One alternative could be the use of much cheaper glass fibers to form a structural energy storing composite. However, to make glass fibers a suitable replacement for carbon fibers for such applications, the glass fibers must become electrically conductive. Although methods to make glass fibers conductive are known, these methods have not been applied to fabricate glass fiber-based energy storing composites as high strength structural panels.

Thus, there exists a need for an improved approach to store energy that can be used, for example, to power electric vehicles.

### BRIEF DESCRIPTION OF THE DRAWINGS

A more complete understanding of the present disclosure, and the attendant advantages and features thereof, will be more readily understood by reference to the following description when considered in conjunction with the accompanying drawings wherein:

FIG. 1A shows CU coated glass fiber mats.

FIG. 1B shows Ni coated glass fiber mats.

FIG. 2A shows Zn coated Cu-GF (Zn/Cu-GF).

FIG. 2B shows Mn₃O₄ deposited Ni-GF (Mn₃O₄/Ni-GF).

FIG. 3 shows PANa hydrogel based solid electrolyte.

FIG. 4 illustrates a stacking pattern of the anode and cathode glass fiber mats to fabricate a large area energized composite.

FIG. 5 shows cyclic voltammetry (CV) curves for a Mn₃O₄/Zn battery at a scan rate of 0.1 m V s¹.

FIG. 6 schematically illustrates another stacking pattern of the anode and cathode glass fiber mats to fabricate a large area energized composite.

### SUMMARY OF THE DISCLOSURE

One aspect of the disclosure relates to an electric vehicle body panel comprising at least one glass fiber-based composite battery or hybrid supercapacitor battery device. In some embodiments, the at least one battery or hybrid supercapacitor battery device comprises a plurality of battery or hybrid supercapacitor battery devices. The plurality of battery or hybrid supercapacitor battery devices can be connected in series and parallel combinations.

In preferred embodiments, the at least one battery or hybrid supercapacitor battery device comprises: a first cathode including cathode material patches at spaced locations on a first cross-weaved glass fiber mat with a first conductive coating, the deposited cathode material patches collectively having a first configuration; a first anode including anode material patches at spaced locations on a second cross-weaved glass fiber mat with a second conductive coating, the deposited anode material patches collectively having a second configuration that matches the first configuration; and a first separator cross-weaved glass fiber mat positioned between the first and second cross-weaved glass fiber mats. The first and second cross-weaved glass fiber mats are stacked so that the cathode material patches substantially align with the anode material patches. The first separator cross-weaved glass fiber mat includes electrolyte coating patches, with the electrolyte coating patches having a third configuration that matches the first and second configurations. The spaces between the cathode material patches, the anode material patches, and the electrolyte coating patches include a filler material.

Additionally, the body panel can further comprise: a second cathode including cathode material patches at spaced locations on a third cross-weaved glass fiber mat with the first conductive coating, the deposited cathode material patches collectively having a fourth configuration; a second anode including anode material patches at spaced locations on a fourth cross-weaved glass fiber mat with the second conductive coating, the deposited anode material patches collectively having a fifth configuration that matches the fourth configuration; and a second separator cross-weaved glass fiber mat positioned between the third and fourth cross-weaved glass fiber mats. The third and fourth cross-weaved glass fiber mats are stacked so that the cathode material patches substantially align with the anode material patches. The stacked third and fourth cross-weaved glass fiber mats and second separator cross-weaved glass fiber mat and the stacked first and second cross-weaved glass fiber mats and first separator cross-weaved glass fiber mat are stacked with a first insulator cross-weaved glass fiber mat positioned between the second and third cross-weaved glass fiber mats. The first and fourth cross-weaved glass fiber mats are electrically connected in series. The second separator cross-weaved glass fiber mat includes electrolyte coating patches on both sides, the electrolyte coating patches having a sixth configuration that matches the fourth and fifth configurations. The spaces between the cathode material patches, the anode material patches, and the electrolyte coating patches include a filler material.

The filler material can comprise an epoxy resin. The electrolyte coating patches can comprise a PANa hydrogel electrolyte.

Another aspect of the disclosure relates to an energy storing device comprising at least one glass fiber-based composite battery or hybrid supercapacitor battery device. The at least one battery or hybrid supercapacitor battery device can comprise a plurality of battery or hybrid supercapacitor battery devices. The plurality of battery or hybrid supercapacitor battery devices can be connected in series and parallel combinations.

In preferred embodiments, the at least one battery or hybrid supercapacitor battery device comprises: a first cathode including cathode material patches at spaced locations on a first cross-weaved glass fiber mat with a first conductive coating, the deposited cathode material patches collectively having a first configuration; a first anode including anode material patches at spaced locations on a second cross-weaved glass fiber mat with a second conductive coating, the deposited anode material patches collectively having a second configuration that matches the first configuration; and a first separator cross-weaved glass fiber mat positioned between the first and second cross-weaved glass fiber mats. The first and second cross-weaved glass fiber mats are stacked so that the cathode material patches substantially align with the anode material patches. The first separator cross-weaved glass fiber mat includes electrolyte coating patches, with the electrolyte coating patches having a third configuration that matches the first and second configurations. The spaces between the cathode material patches, the anode material patches, and the electrolyte coating patches include a filler material.

Additionally, the energy storing device can further comprise: a second cathode including cathode material patches at spaced locations on a third cross-weaved glass fiber mat with the first conductive coating, the deposited cathode material patches collectively having a fourth configuration; a second anode including anode material patches at spaced locations on a fourth cross-weaved glass fiber mat with the second conductive coating, the deposited anode material patches collectively having a fifth configuration that matches the fourth configuration; and a second separator cross-weaved glass fiber mat positioned between the third and fourth cross-weaved glass fiber mats. The third and fourth cross-weaved glass fiber mats are stacked so that the cathode material patches substantially align with the anode material patches. The stacked third and fourth cross-weaved glass fiber mats and second separator cross-weaved glass fiber mat and the stacked first and second cross-weaved glass fiber mats and first separator cross-weaved glass fiber mat are stacked with a first insulator cross-weaved glass fiber mat positioned between the second and third cross-weaved glass fiber mats. The first and fourth cross-weaved glass fiber mats are electrically connected in series. The second separator cross-weaved glass fiber mat includes electrolyte coating patches on both sides, the electrolyte coating patches having a sixth configuration that matches the fourth and fifth configurations. The spaces between the cathode material patches, the anode material patches, and the electrolyte coating patches include a filler material.

The filler material can comprise an epoxy resin. The electrolyte coating patches can comprise a PANa hydrogel electrolyte.

### DETAILED DESCRIPTION

As required, embodiments are disclosed herein; however, it is to be understood that the disclosed embodiments are merely examples and that the methods described below can be embodied in various forms. Therefore, specific structural and functional details disclosed herein are not to be interpreted as limiting, but merely as a representative basis for teaching one skilled in the art to variously employ the present subject matter in virtually any appropriately detailed structure and function. Further, the terms and phrases used herein are not intended to be limiting, but rather, to provide an understandable description of the concepts.

It can be advantageous to set forth definitions of certain words and phrases used throughout this disclosure. The terms “a” or “an”, as used herein, are employed to describe elements and components described herein. This is done merely for convenience and to give a general sense of the scope of the disclosure. This description should be read to include one or at least one and the singular also includes the plural unless it is obvious that it is meant otherwise. The term plurality, as used herein, is defined as two or more than two. The term another, as used herein, is defined as at least a second or more.

The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, or C; A and B; A and C; B and C; and A, B, and C.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Note that not all of the activities described above in the general description or the examples are required, that a portion of a specific activity may not be required, and that one or more further activities can be performed in addition to those described. Still further, the order in which activities are listed are not necessarily the order in which they are performed.

In general, one aspect of the disclosure relates to an economically feasible solution to the problem of increasing the miles/charge of an EV without adding extra weight by storing energy in one or more body panels of the EV. As disclosed herein, this can be achieved by using glass fiber-based composite supercapacitors or hybrid supercapacitor battery devices which can act as both energy and structural component of the car body.

To make the glass fibers electrically conductive, any suitable method, such as electroless deposition of conductive materials like copper or nickel, can be used. Further using anode and cathode materials such as Manganese (II, III) oxide (Mn₃O₄) and Zinc (Zn), cathode and anode mats can be made on copper and nickel coated glass fibers via hydrothermal and electro deposition methods. Once the anode and cathode mats are formed in an alternating square patterned arrangement using copper and nickel coated glass fiber as current collector, a device with a capacity of >300 mAh/g at 0.1 A/g can be assembled using an alternating system of epoxy and electrolyte. Uncoated pristine glass fiber ladened and patterned with electrolyte can be used as a separator. Uncoated pristine glass fiber ladened with epoxy can be used as an insulator between two devices.

### Electrically Conductive Glass Fibers

One non-limiting exemplary method to make glass fibers electrically conductive is electroless deposition. Although the following uses copper and nickel as non-limiting exemplary examples of conductive materials, the disclosure contemplates the use of other conductive materials.

For example, a Ni/Ni combination can be worked out if other active materials such as graphite etc. can be coated onto the Ni coated glass fibers using slurry deposition method for the anode.

### Copper Coating on Glass Fiber (Cu-GF)

A. Treatment of fibers: The glass fibers used were a commercially available product, FibreGlast 241 2 oz fiberglass fabric (Fibre Glast Developments Corporation, Brookville, OH, www.fibreglast.com) having the following properties:
   Finish: Compatible with Polyester, Vinyl Ester, & Epoxy
   Weave Pattern: Plain
   Yard Description: Warp: ECG 150 1/0—Fill: ECG 150 1/0
   Count: Ends×Picks (in): 32×27
   Weight: 2.38 oz/yd²
   Breaking Strength (lb/in): Warp: >35 lb/in—Fill: >30 lb/in
   Thickness: 0.0035 in

The disclosure contemplates that glass fibers have other properties can be used.

The pristine glass fibers are washed with DI water to remove any contaminants and dried at about 60° C. for about 2 hours. Other washing and drying processes can be used. These glass fiber mat can be cut to the electrode's desired size and then sensitized with 30 g l⁻¹ SnCl₂ and 60 ml l⁻¹ HCl for about 10 minutes. This operation can be performed by simply dipping the fibers in the tin chloride solution for about 10 minutes. The fibers are removed from the solution and dried (at about 60° C.). Next, the fibers are activated with a solution containing 0.25 g l⁻¹ PdCl₂ and 60 ml l⁻¹ HCl. Again, this process can be completed by simply dipping the sensitized fibers in palladium chloride solution for about 10 mins. Then the fibers can be taken out and dried at about 60° C.

To aid the sensitization process via removing the smoothness of glass fiber surface and increasing its surface roughness, the glass fibers can be dry etched (plasma etching). This can also be achieved by other methods such as treating with acid solutions.

B. Electroless deposition solution preparation: First, a 100 ml 0.15 M copper sulfate solution in DI water is prepared into which 4 g of Potassium sodium tartrate is added as complexing agent. The solution is stirred for about 10 mins and then 2 g of NaOH is added, resulting in the solution having a navy-blue color after 10 mins of stirring.

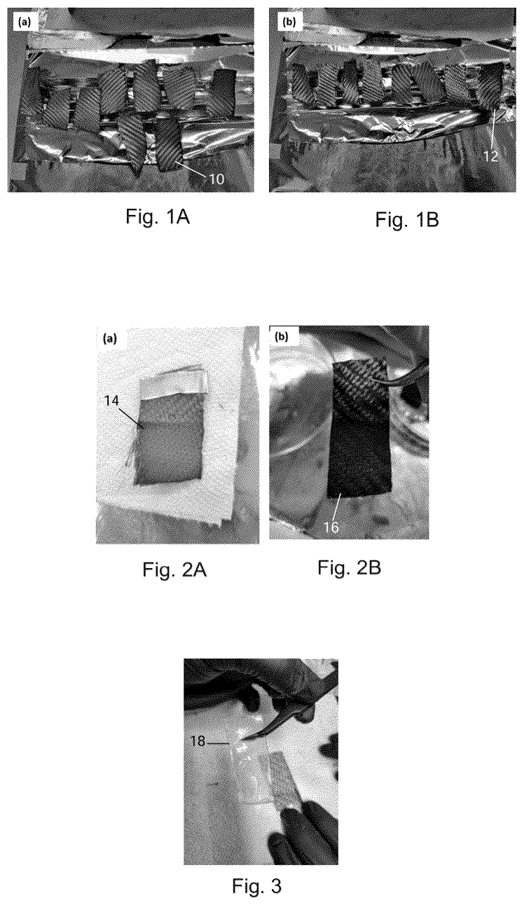

C. Copper deposition on glass fibers: 1.50 ml of formaldehyde is added to the above solution and the sensitized and activated glass fibers are immediately immersed in the solution at about 30° C. The coating is completed in about 15 mins. The copper coated glass fiber mats 10 are shown in FIG. 1A, after removal from the solution and drying.

### Nickel Coating on Glass Fiber (Ni-GF)

A. Treatment of fibers: First pristine glass fibers (described above) are washed with DI water to remove any contaminants and dried at about 60° C. for about 2 hours. Other washing and drying processes can be used. These glass fiber mat can be cut to the electrode's desired size and then sensitized with 30 g l⁻¹ SnCl₂ and 60 ml l⁻¹ HCl for about 10 minutes. This operation can be performed by simply dipping the fibers in the tin chloride solution for about 10 minutes. Further the fibers are taken out and dried (at about 60° C.) and then activated with a solution containing 0.25 g l⁻¹ PdCl₂ and 60 ml l⁻¹ HCl. Again, this process can be completed by simply dipping the sensitized fibers in palladium chloride solution for about 10 mins. Then the fibers can be taken out and dried at about 60° C.
B. Nickel deposition on glass fibers: The electroless nickel deposition is carried out by immersing the GF mat into an aqueous bath at about 45° C. for about 20 minutes. The nickel-plating bath contains NiSO₄·6H₂O (4 g), Na₂P₂O₇·10H₂O (8 g), NaH₂PO₂·H₂O (2 g), and (CH₂CH₂OH)₃N (3 ml) in 100 ml DI water.
C. Annealing of nickel coated glass fibers: Following the electroless deposition, the Ni-coated GF mat (Ni-GF) was washed multiple times with deionized water and dried at about 50° C. in air for about 2 hours in an oven. Finally, the Ni-GF electrodes were annealed at about 500° C. for about 3 hours under N₂ atmosphere to increase nickel crystallinity. The nickel coated glass fiber mats 12 are shown in FIG. 1B.

### Anode and Cathode Material Deposition

One non-limiting exemplary deposition method is electroplating. Although the following uses zinc and manganese as non-limiting exemplary examples of anode and cathode materials, the disclosure contemplates the use of other materials. Other possible combinations include: Anode-graphite, Aluminum; and Cathode-Nickel (Ni), Cobalt (Co) or combination of Nickel & Cobalt (Ni+Co).

### Deposition of Anode Active Material (Zn) on Cu-Coated GF Mat

A. Prepare the solution: A solution containing 1 M ZnSO₄ in deionized water is prepared. The Cu-GF substrate is immersed in the solution.
B. Electroplating: The electroplating of the anode is carried out for about 30 minutes at about −0.8 V using a CHI660E electrochemical workstation. The Zn foil is used as the reference and counter electrode.
C. Washing and drying: After electroplating, the Zn/Cu-GF anode is washed several times with deionized water to remove any impurities. It is then dried at about 50° C. for about 6 hours. The resultant anode electrode can be seen in FIG. 2A.
   Deposition of Cathode Active Material, Mn₃O₄ or MnO₂ on Ni-Coated GF Mat
A. Prepare the solution: A solution containing 0.06 M potassium permanganate (KMnO₄) in deionized water is prepared. The Ni-GF substrate is immersed in the solution.
B. a) Mn₃O₄ deposition-Hydrothermal treatment: After immersion, the substrate is subjected to a hydrothermal treatment in a Teflon-lined stainless-steel autoclave. The autoclave is heated to about 150° C. and maintained at this temperature for about 4 hours. The hydrothermal treatment results in the formation of Mn₃O₄ nanostructures on the Ni-GF substrate. The process occurs due to the reduction of potassium permanganate and the oxidation of the substrate material by the hydrothermal environment.
C. b) MnO₂ deposition: The deposition of MnO₂ can also be performed via the hydrothermal process using a potassium permanganate precursor solution.
D. After treatment: After the hydrothermal treatment, the autoclave is allowed to cool naturally. The resulting Mn₃O₄/Ni-GF mat is then thoroughly washed with DI water to remove any impurities and residual chemicals from the surface. The washed Mn₃O₄/Ni-GF mat is then dried at about 50° C. for about 6 hours in an oven.
E. Annealing: Finally, the Mn₃O₄/Ni-GF mat electrode is annealed at about 400° C. for about 3 hours to enhance the crystallinity of the Mn₃O₄ nanostructures. The resultant cathode electrode 16 can be seen in FIG. 2B.

### Electrolyte Preparation

Although the following uses a PANa hydrogel as a non-limiting exemplary example of an electrolyte, the disclosure contemplates the use of other electrolytes.
A. Dissolution of acrylic acid & NaOH: 44 ml of acrylic acid (AA) is added to 50 ml of de-ionized water under constant stirring in an ice bath. In a separate beaker, 26.7 g of sodium hydroxide (NaOH) is dissolved in 18 g of de-ionized water to create a concentrated NaOH solution. The concentrated NaOH solution is slowly added into the AA solution in a 0° C. ice bath to neutralize it.
B. Polymerization: 0.78 g of ammonium persulfate (APS) is added into the neutralized solution and stirred for about 0.5 h at room temperature (25° C.) to initiate polymerization. Free-radical polymerization is initiated in an oven at about 40° C. for about 30 hours.
C. Solid electrolyte preparation: After free-radical polymerization, the hydrogel is peeled off and fully dried in an oven at about 100° C. for 2 hours. The PANa hydrogel is immersed in a concentrated solution (200 mL) of 2 M ZnSO₄ and 0.5 M MnSO₄ for up to about a week to convert it into a fully functional solid electrolyte, as shown in FIG. 3.
D. Polymer film thickness optimization: For a given glass fiber-based energy-storing composite (length, width, thickness, composition), the thickness of PANa polymer can be optimized by preparing a series of polymer film thickness and study the charge transfer kinetics using an electrochemical workstation. The film with optimized thickness can be used for developing the glass fiber composite.

### Device Assembly and Fabrication

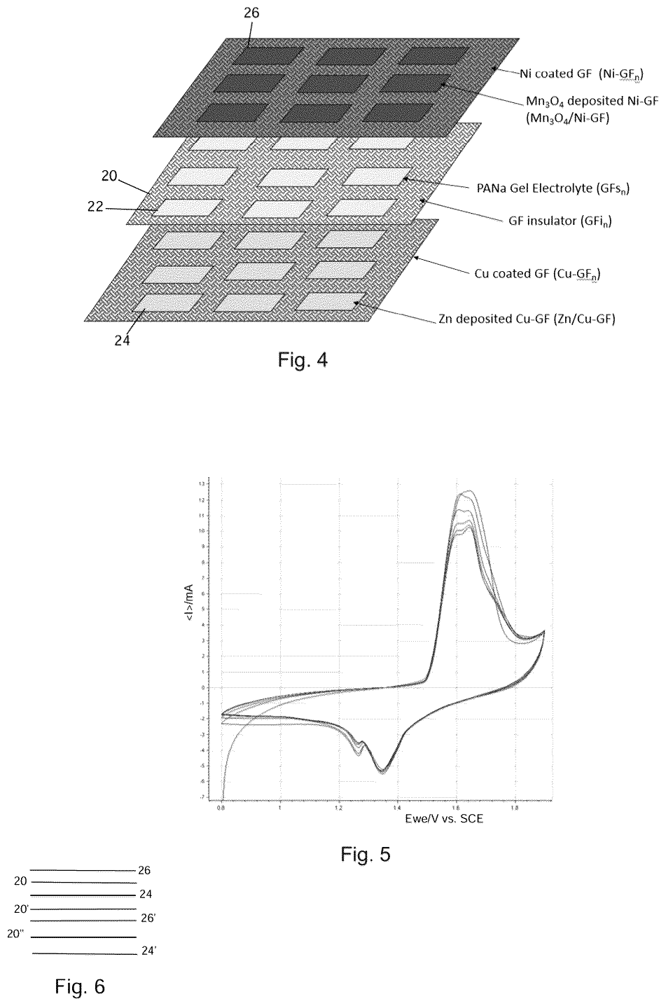

An exemplary configuration for series stacking of n-number of devices is shown in FIG. 4. In the configuration, GFin (20) represents the glass fiber used as an insulator of the n^{th} layer and GFsₙ (22) represents the polymer solid electrolyte separator between the Zn/Cu-GF anode (24) and Mn₃O₄/Ni-GF cathode (26) of the n^{th} device. The GFs would also have the same location-based pattern of PANa gel electrolyte on an anode/cathode mat. To make the patches shown in FIG. 4, any known masking technique can be used during the anode and cathode material deposition. The patches of electrolyte can be made by applying the PANa gel film to the glass fiber layer to match. The remaining areas on the GFs are applied with binding epoxy to form the bond with its adjacent cross weaved glass fiber mats (CWGFMs). Epoxy is applied on both sides to enable strong bonding between the layers of the adjacent devices.

FIG. 4 shows the minimum of 2 layers of coated glass fibers with active materials (one anode 24 and one cathode 26) is needed in a stack to make a device. Additionally, a plain glass fiber fabric is added in middle as insulator (glass fiber 20 with polymer solid electrolyte 22). Regardless of the number of layers, a plain glass fiber fabric is used in the middle of any two coated glass fiber fabrics with active materials to provide better insulation. The number of devices in a stack can be increased based on the application processes:
2 coated glass fiber layers with active materials+1 plain glass fiber fabric as insulator
4 coated glass fiber layers with active materials+3 plain glass fiber fabric as insulator
6 coated glass fiber layers with active materials+5 plain glass fiber fabric as insulator.

Although additional layers can be used, further increase in the layers for the stack up will make the composite thicker, possibly limiting its practical applications.

FIG. 6 schematically illustrates four coated glass fiber layers with active materials and three plan glass fiber layers as an insulator. Specifically, two anode layers 24 and 24′ and two cathode layers 26 and 26′ with three plain glass fiber layers 20, 20′, 20″ as insulator.

Although FIG. 4 shows use of glass fibers only, the disclosure contemplates that one side can be glass fiber and the other side carbon fibers to make the devices. The Zn and Mn depositions can be performed on the carbon fibers in a similar way as done on the coated glass fibers (see also the incorporated by reference patents and applications). Ni and Co hydroxides and sulfides can be deposited on carbon fibers for the cathode (again see also the incorporated by reference patents and applications). The inclusion of carbon fibers will further increase the mechanical strength of the composite.

### Electrochemical Characterization: CV, GCD and EIS Result Discussion

The electrochemical performance of Zinc-ion batteries (ZIBs) (samples of 5 cm×2 cm with Cu and Ni coatings and 2 cm×2 CM active material deposition of Zn and Mn)) was evaluated using a two-electrode setup with Zn/Cu-GF as the anode and Mn₃O₄/Ni-GF as the cathode, and a CHI660E electrochemical workstation at room temperature. The aqueous electrolyte for all electrochemical tests was a 2 M ZnSO₄+0.5 M MnSO₄ solution. Cyclic voltammetry (CV) tests were conducted over a voltage range of about 0.8-1.9 V at a scan rate of about 0.1 m V s⁻¹, as depicted in FIG. 5.

During the cathodic scanning of Mn₃O₄ in the ZIB, two reduction peaks at about 1.4 V and about 1.2 V correspond to the reduction of Mn⁴⁺ to Mn³⁺. This reduction is thought to be caused by either H⁺ and/or Zn²⁺ insertion/co-insertion. The discharge of Mn₃O₄ results in the deposition of a zinc complex salt (ZnSO₄[Zn(OH)₂]₃·xH₂O) on the cathode surface due to local pH changes. Upon anodic scanning, the salt dissolves, and Mn³⁺ is reoxidized to Mn⁴⁺. The Zn anode side undergoes Zn discharge as Zn→Zn²⁺+2^{e-}. The solid state ZIB device will be fabricated via leveraging the liquid electrolyte based ZIB chemistry. Further evaluation of the electrochemical performance of solid state ZIB device can be performed via charge discharge (GCD), EIS and cycling performance tests.

The data indicates that energy-storing glass fiber-based composites can be used to make body panels of electric vehicles, such as electric cars, trucks, aircrafts, space vehicles, drones, etc. These glass fiber composites are used to make supercapacitors or hybrid supercapacitor battery devices with high tensile strength and impact energy. Therefore, these composites can be used to make body panels of automobiles and building components of aircraft and space vehicles.

Body panels that can store energy transform the energy logistics for the electric vehicle customers—being strong, practically unlimited charging, non-toxic, non-flammable, and lightweight. This transformative approach satisfies the energy needs of electric vehicles by storing energy in their body panels in addition to the existing batteries. Although an electric vehicle body panel has been used as an exemplary embodiment, the disclosure contemplates other applications of the glass fiber-based energy storage disclosed herein. For example, the glass fiber-based composite supercapacitor or hybrid supercapacitor battery could be used as a structural component for different electrical devices and appliances.

All references cited herein are expressly incorporated by reference in their entirety. It will be appreciated by persons skilled in the art that the present disclosure is not limited to what has been particularly shown and described herein above. In addition, unless mention was made above to the contrary, it should be noted that all of the accompanying drawings are not to scale. There are many different features to the present disclosure and it is contemplated that these features may be used together or separately. Thus, the disclosure should not be limited to any particular combination of features or to a particular application of the disclosure. Further, it should be understood that variations and modifications within the spirit and scope of the disclosure might occur to those skilled in the art to which the disclosure pertains. Accordingly, all expedient modifications readily attainable by one versed in the art from the disclosure set forth herein that are within the scope and spirit of the present disclosure are to be included as further embodiments of the present disclosure.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended representative claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the representative claims.

After reading the disclosure, skilled artisans will appreciate that certain features are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

The above discussion is meant to be illustrative of the principles and various embodiments of the present invention. Numerous variations and modifications will become apparent to those skilled in the art once the above disclosure is fully appreciated. It is intended that the following representative claims be interpreted to embrace all such variations and modifications.

What is claimed is:

1. An electric vehicle body panel comprising at least one glass fiber-based composite battery or hybrid supercapacitor battery device.

2. The body panel of claim 1, wherein the at least one battery or hybrid supercapacitor battery device comprises a plurality of battery or hybrid supercapacitor battery devices.

3. The body panel of claim 2, wherein the plurality of battery or hybrid supercapacitor battery devices is connected in series and parallel combinations.

4. The body panel of claim 1, wherein the at least one battery or hybrid supercapacitor battery device comprises:
a first cathode including cathode material patches at spaced locations on a first cross-weaved glass fiber mat with a first conductive coating, the deposited cathode material patches collectively having a first configuration;
a first anode including anode material patches at spaced locations on a second cross-weaved glass fiber mat with a second conductive coating, the deposited anode material patches collectively having a second configuration that matches the first configuration; and
a first separator cross-weaved glass fiber mat positioned between the first and second cross-weaved glass fiber mats,
wherein the first and second cross-weaved glass fiber mats are stacked so that the cathode material patches substantially align with the anode material patches;
wherein the first separator cross-weaved glass fiber mat includes electrolyte coating patches, the electrolyte coating patches having a third configuration that matches the first and second configurations; and
wherein the spaces between the cathode material patches, the anode material patches, and the electrolyte coating patches include a filler material.

5. The body panel of claim 4, further comprising:
a second cathode including cathode material patches at spaced locations on a third cross-weaved glass fiber mat with the first conductive coating, the deposited cathode material patches collectively having a fourth configuration;
a second anode including anode material patches at spaced locations on a fourth cross-weaved glass fiber mat with the second conductive coating, the deposited anode material patches collectively having a fifth configuration that matches the fourth configuration; and
a second separator cross-weaved glass fiber mat positioned between the third and fourth cross-weaved glass fiber mats,
wherein the third and fourth cross-weaved glass fiber mats are stacked so that the cathode material patches substantially align with the anode material patches;
wherein the stacked third and fourth cross-weaved glass fiber mats and second separator cross-weaved glass fiber mat and the stacked first and second cross-weaved glass fiber mats and first separator cross-weaved glass fiber mat are stacked with a first insulator cross-weaved glass fiber mat positioned between the second and third cross-weaved glass fiber mats;
wherein the first and fourth cross-weaved glass fiber mats are electrically connected in series;
wherein the second separator cross-weaved glass fiber mat includes electrolyte coating patches on both sides, the electrolyte coating patches having a sixth configuration that matches the fourth and fifth configurations; and
wherein the spaces between the cathode material patches, the anode material patches, and the electrolyte coating patches include a filler material.

6. The body panel of claim 5, wherein the filler material comprises an epoxy resin.

7. The body panel of claim 5, wherein the electrolyte coating patches comprise a PANa hydrogel electrolyte.

8. An energy storing device comprising at least one glass fiber-based composite battery or hybrid supercapacitor battery device.

9. The energy storing device of claim 8, wherein the at least one battery or hybrid supercapacitor battery device comprises a plurality of battery or hybrid supercapacitor battery devices.

10. The energy storing device of claim 9, wherein the plurality of battery or hybrid supercapacitor battery devices is connected in series and parallel combinations.

11. The energy storing device of claim 8, wherein the at least one battery or hybrid supercapacitor battery device comprises:
a first cathode including cathode material patches at spaced locations on a first cross-weaved glass fiber mat with a first conductive coating, the deposited cathode material patches collectively having a first configuration;
a first anode including anode material patches at spaced locations on a second cross-weaved glass fiber mat with a second conductive coating, the deposited anode material patches collectively having a second configuration that matches the first configuration; and
a first separator cross-weaved glass fiber mat positioned between the first and second cross-weaved glass fiber mats,
wherein the first and second cross-weaved glass fiber mats are stacked so that the cathode material patches substantially align with the anode material patches;
wherein the first separator cross-weaved glass fiber mat includes electrolyte coating patches, the electrolyte coating patches having a third configuration that matches the first and second configurations; and
wherein the spaces between the cathode material patches, the anode material patches, and the electrolyte coating patches include a filler material.

12. The energy storing device of claim 11, further comprising:
a second cathode including cathode material patches at spaced locations on a third cross-weaved glass fiber mat with the first conductive coating, the deposited cathode material patches collectively having a fourth configuration;
a second anode including anode material patches at spaced locations on a fourth cross-weaved glass fiber mat with the second conductive coating, the deposited anode material patches collectively having a fifth configuration that matches the fourth configuration; and
a second separator cross-weaved glass fiber mat positioned between the third and fourth cross-weaved glass fiber mats,
wherein the third and fourth cross-weaved glass fiber mats are stacked so that the cathode material patches substantially align with the anode material patches;
wherein the stacked third and fourth cross-weaved glass fiber mats and second separator cross-weaved glass fiber mat and the stacked first and second cross-weaved glass fiber mats and first separator cross-weaved glass fiber mat are stacked with a first insulator cross-weaved glass fiber mat positioned between the second and third cross-weaved glass fiber mats;
wherein the first and fourth cross-weaved glass fiber mats are electrically connected in series;
wherein the second separator cross-weaved glass fiber mat includes electrolyte coating patches on both sides, the electrolyte coating patches having a sixth configuration that matches the fourth and fifth configurations; and
wherein the spaces between the cathode material patches, the anode material patches, and the electrolyte coating patches include a filler material.

13. The energy storing device of claim 12, wherein the filler material comprises an epoxy resin.

14. The energy storing device of claim 12, wherein the electrolyte coating patches comprise a PANa hydrogel electrolyte.
